(19) United States
(12) Patent Application Publication
(10) Pub. No.: US 2025/0209340 A1
(43) Pub. Date: Jun. 26, 2025

(54) INTRA-AGENT SPEECH TO FACILITATE TASK LEARNING

(71) Applicant: DeepMind Technologies Limited, London (GB)

(72) Inventors: Chen Yan, London (GB); Federico Javier Carnevale, London (GB); Petko Ivanov Georgiev, London (GB); Adam Anthony Santoro, London (GB); Aurelia Adrianna Guy, San Luis Obispo, CA (US); Alistair Michael Muldal, London (GB); Chia-Chun Hung, London (GB); Joshua Simon Abramson, London (GB); Timothy Paul Lillicrap, London (GB); Gregory Duncan Wayne, London (GB)

(21) Appl. No.: 18/851,177

(22) PCT Filed: May 19, 2023
(86) PCT No.: PCT/EP2023/063494

§ 371 Date: Sep. 26, 2024

Related U.S. Application Data
(60) Provisional application No. 63/343,905, filed on May 19, 2022.

(51) Int. Cl. G06N 3/096; G06N 3/0455; G06N 3/092

(52) U.S. Cl. CPC G06N 3/096; G06N 3/0455; G06N 3/092

(57) ABSTRACT

Systems, methods, and computer programs for learning to control an embodied agent to perform tasks. The techniques use internal, “intra-agent” speech when learning, and are thus able to perform tasks involving new objects without any direct experience of interacting with those objects, i.e. zero-shot. Implementations of the techniques use an image captioning neural network system to generate natural language captions used when training an action selection neural network system.

### BACKGROUND

This specification generally relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes systems and methods, implemented as computer programs on one or more computers in one or more locations, for learning to control an agent, e.g. an embodied agent, to perform tasks. The described techniques use language when learning, more particularly internal, intra-agent speech, and are thus able to perform tasks involving new objects without any direct experience of interacting with those objects, i.e. zero-shot.

In one aspect there is described a computer-implemented method of training an action selection neural network system to control an agent to select actions to perform a task in an environment.

The method involves obtaining multimodal demonstration data sequences of demonstration observations and demonstration actions. The demonstration observations comprise image observations that characterize states of the environment while a demonstrating agent performs a task in the environment, and one or more natural language observations.

An action selection neural network system is configured to process an embedding of an image of the environment and an embedding of a natural language input, to generate an action selection policy output for selecting an action to be performed by the agent, and a language policy output for generating a natural language output.

The method involves processing embeddings of the demonstration observations using the action selection neural network system to generate the action selection policy output and the language policy output for the demonstration observations. The action selection neural network system is trained, using a natural language output defined by the language policy output, such that actions defined by the action selection policy outputs from the action selection neural network system are encouraged to match the actions of the demonstrating agent.

Image observations from the demonstration observations are processed using an image captioning neural network system to generate natural language captions for the image observations. The training of the action selection neural network system involves training the action selection neural network system using the natural language captions.

The subject matter described in this specification can be implemented in particular embodiments so as to realize one or more of the following advantages.

Implementations of the described systems and methods emulate the use of “inner speech” by humans, that is they generate speech that describes the environment as a task progresses. This can help the agent to generalize when learning to perform a task. Thus the system can perform new tasks without any additional training.

For example after having been trained to move or manipulate some objects the system can move or manipulate a new object without any previous training that has involved tasks relating to that object, e.g. without the new object having been included in any task-related instructions during the training. The new object is identified using natural language. The system knows about the new object because the image captioning neural network system describes the environment and identifies objects. This natural language information is used as the system learns to perform tasks involving other objects, so that it can also perform tasks that involve the new object.

Also described are techniques for learning to generate captions for images using less data than some other approaches. These techniques can train an image captioning neural network system by relying on a dataset of images only a small proportion of which have been provided with captions, e.g. by humans. Typically generating image captions for training an image captioning neural network system is time-consuming and costly. The described techniques can impute the missing information, making efficient use of the information that is available.

In general implementations of the described techniques facilitate efficient learning by using language to help understand the world, and can thus reduce the memory and compute resources needed to train a system used to control an agent.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of an action selection system.

FIG. 2 shows a particular example implementation of an action selection neural network system.

FIG. 3 is a flow diagram of an example process for training an action selection system.

FIG. 4 illustrates an example implementation of the training process of FIG. 3.

FIG. 5 shows a system for training an image captioning neural network system.

FIG. 6 shows an example process for training an image captioning neural network system.

FIG. 7 illustrates operation of the system of FIG. 5.

FIG. 8 illustrates the performance of an example implementation of the system of FIG. 1.

FIG. 9 shows an example of an agent system configured to control an agent.

FIG. 10 is a flow diagram of an example process for controlling an agent.

Like reference numbers and designations in the various drawings indicate like elements.

### DETAILED DESCRIPTION

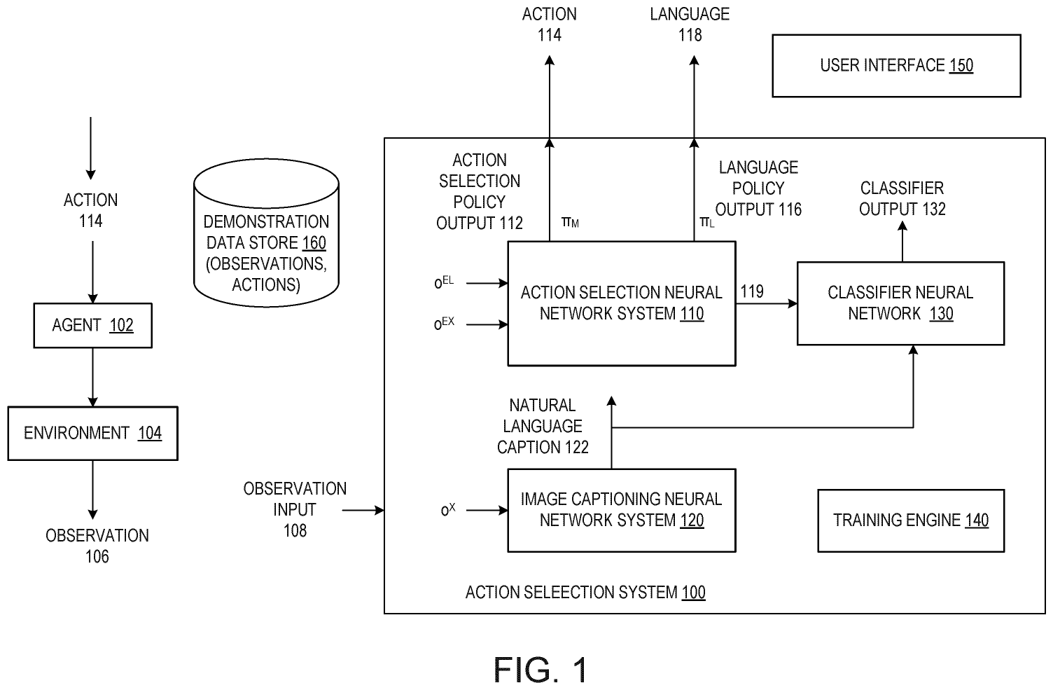

FIG. 1 shows an example of an action selection system 100 that may be implemented as one or more computer programs on one or more computers in one or more locations. The action selection system 100 is trained using demonstration data and can then be used to control an agent 102, e.g. an embodied agent, interacting with an environment 104 to perform a task, based on observations 106 of the environment. The observations include images, and the system uses a captioning neural network system to obtain a natural language description of the images. During training, as the system interacts with some objects in the environment it uses natural language captions describing other objects it sees to help the training to generalize. For example some implementations of the system can perform tasks using the other, “new” objects without having been trained by interacting with these objects, i.e. the system can exhibit “zero-shot task acquisition”.

In some implementations the action selection neural network system 100 is helped to generalize by training the action selection neural network system using an auxiliary loss based on the natural language captions. For example the captions can be used as an auxiliary input to the system during training, and/or can be used as a training target. The auxiliary loss may be a caption loss or a caption matching loss as described later.

In general the action selection system 100 receives language observations, i.e. language inputs, as well as image observations, and in some implementations also generates language outputs. This allows the system to answer questions, participate in dialog, ask for clarifications, and so forth.

Referring again to FIG. 1, the action selection system 100 has at least one observation input 108 to receive observations, comprising image observations, i.e. still or moving image observations, and natural language observations. In general an image observation characterizes a state of an environment; after training the image observations may comprise observations of the environment 104. As used herein an image can be obtained from a camera or other image sensor e.g. “image” includes a LIDAR point cloud. The natural language observations input to the system in general relate to the environment, more specifically to a task performed in the environment, and may comprise e.g. a description of the environment, or of a task to be performed by the system in the environment, or dialog in relation to these. In general an observation is obtained for each of a succession of time steps; typically each time step will include an image observation but a natural language observation need not be present at each time step. In general at least one of the natural language observations describes a task that is being performed. In some implementations some natural language observations may be repeated at multiple time steps, e.g., at each time step until a new natural language observation is received, i.e. some natural language observations may be “sticky”. An observation may include a representation of a history of previous observations.

During training the image observations and the natural language observations may be obtained from a local or remote demonstration data store 160. During further training, or after training, the observations may be obtained from the environment 104. In some implementations the system can be trained partially or wholly using data from a simulation of a real-world environment, and then used in the real-world environment. In general after training the image observations are derived from images of the environment 104. After training the natural language observations may be derived from a local or remote text or spoken input, e.g. via a local or remote user interface 150.

An observation is processed by the action selection system 100 to generate an embedding of an observation received at the observation input 108, comprising an embedding (o^{EX}) of an image (o^{X}) of the environment, and an embedding (o^{EL}) of a natural language input. In implementations the embedding of the observation, in particular the embedding of the image of the environment and the embedding of the natural language input, are processed by an action selection neural network system 110, in accordance with trainable parameters, such as weights, of the action selection neural network system 110, to generate an action selection policy output 112 for selecting an action 114, and a language policy output 116 for generating a natural language output 118. In some implementations the action selection neural network system 110 also generates a combined representation of the natural language input and the image, e.g. at an intermediate output 119.

As used herein an “embedding” of an observation can refer to a representation of the observation as an ordered collection of numerical values, e.g., a vector or matrix of numerical values. An embedding of an observation can be generated, e.g., as the output of a neural network that processes data characterizing the entity, or by multiplying by an embedding matrix. An embedding neural network may have any suitable architecture and may include, e.g., one or more feed forward neural network layers, one or more recurrent neural network layers, one or more convolutional neural network layers, one or more attention neural network layers, or one or more normalization layers.

Merely as an example, the embedding of the image of the environment can be generated by processing the image using a residual neural network (ResNet). The embedding of the natural language input can be generated by an embedding matrix e.g. by indexing a pre-determined or learnable table of a vocabulary of natural language tokens, e.g. words, and their embeddings. In some implementations, but not essentially, the embedding of the image and the embedding of the natural language input have the same dimensionality.

In general an observation is obtained for each of a succession of time steps and the action selection policy output 112 is generated for each of the succession of time steps. The action selection policy output 112 is used for selecting an action 114. The action 114 may be continuous or discrete; it may comprise a set of multiple individual or primitive actions to be performed at a time step e.g. a mixture of continuous and discrete actions. During training the selected actions can, e.g., be compared with actions stored in the demonstration data store 160. During or after training the selected actions can be performed by the agent 102. Performance of the selected actions by the agent 102 generally causes the environment 104 to transition into new states. By repeatedly causing the agent 102 to act in the environment 104 the action selection system 100 can control the agent 102 to complete a specified task.

There are many ways in which the action selection policy output 112 can be used to select actions. For example the action selection policy output 112 may define the action directly, e.g., it may comprise a value used to define a continuous value for an action, such as a torque or velocity. As another example it may define, e.g. parameterize, a continuous or categorical distribution from which a value defining the action may be selected; or it may define a distribution as a set of scores, one for each action of a set of possible actions. Such a distribution can be used for selecting the action, e.g. by sampling from the distribution or by selecting an action with the highest probability. In implementations the action selected by the action selection policy output 112 can be a non-action, i.e. defining that the agent is not to act at a particular time step, or predicting no action at a time step (during training).

In general the neural network outputs described herein may define distributions, e.g. as a set of scores or by outputting parameters defining a distribution. References to a neural network output defining a particular output, such as a particular action or language token, can be interpreted as the neural network output defining the particular output stochastically, e.g. by sampling from the distribution; or the particular output may be defined e.g. by a mean or maximum value of the distribution.

The language policy output 116 may be generated for each of the succession of time steps, or at less frequent intervals. The language policy output may generate language actions in a generally similar way to that in which the action selection policy output 112 generates movement actions. A language action may be an action that defines one or more language tokens to be emitted at a time step. For example it may define a distribution over a vocabulary of possible language tokens from which a language token is then selected. A language token may define a word or part of a word, or multiple words, e.g. a sentence or part of a sentence. Language tokens may include tokens representing punctuation. In some implementations the natural language output is generated a word at a time.

The techniques described herein are not limited to any particular implementation of action selection neural network system 110 (though some implementations require the system to generate the previously described combined representation). In general the action selection neural network system 110 may include, e.g., one or more feed forward neural network layers, one or more recurrent neural network layers, one or more convolutional neural network layers, one or more attention neural network layers, or one or more normalization layers.

The action selection system 100 includes an image captioning neural network system 120. This is used during training and is not needed after training (although it can be retained in case further training is needed). The image captioning neural network system 120 is configured to process a still or moving image observation (o^{x}), in particular in accordance with trainable parameters such as weights, of the image captioning neural network system, to generate a natural language caption 122 (a “caption”) for the image observation. The image observation can be part of a demonstration observation retrieved from the demonstration data store 160; it may be derived from one or more frames of video imagery of a simulated or real environment.

In general the natural language caption describes characteristics of the image observation, o^{X}, in natural language, more particularly characteristics of one or more objects in the image observation. The natural language caption can (but need not) describe characteristics of multiple objects in the image observation, such as one or more of an object name, shape, configuration, contour, color, texture, material and so forth. The natural language caption may also describe the relative disposition of two or more objects in the image observation. In general the particular content of a caption will depend on the data used to train the image captioning neural network system, e.g. on the textual content of human annotated of training images.

In some implementations the action selection system 100 also includes a classifier neural network 130. This is used during training and is not needed after training, although it can be retained, e.g. in case further training is needed. The classifier neural network 130 has trainable parameters, such as weights, and is configured (trained) to process the combined representation of a natural language input and an image obtained from the action selection neural network system 110, e.g. from the intermediate output 119, in accordance with the trainable parameters, to generate a classifier output 132.

More particularly the classifier neural network 130 is configured to process the combined representation generated, by the action selection neural network system 110, from processing the embedding of an image and the embedding of natural language caption from the image captioning neural network system 120. The image may be one from which the caption was generated, or a different image. The classifier output 132 is configured to predict whether (or not) the natural language caption and the image match, i.e. whether (or not) the image one from which the caption was generated, e.g. whether (or not) the caption and image were obtained from the same image observation. For example the classifier output 132 may comprise a score that predicts, based on a value of the score, whether or not the natural language caption and the image observation match. The classifier neural network 130 may also be thought of as a discriminator neural network.

As previously mentioned, the action selection system 100 is provided with the demonstration data store 160 as a source of multimodal demonstration data for training the system. In implementations the multimodal demonstration data comprises a plurality of task demonstration sequences. Each of these may comprise a sequence or “trajectory” of demonstration observations and demonstration actions. The demonstration data is multimodal in that the demonstration observations comprise both image observations and language observations.

The demonstration observations may comprise image observations that characterize states of an environment while a demonstrating agent interacts with the environment to perform a task. The environment may be the environment in which the agent will act after training, or it may be another similar, environment, or it may be a simulation or representation of this environment. Image observations of a simulated environment may characterize states of the environment that is simulated. As an example the agent may be trained using a simulation of a real-world environment, e.g. a type of real-world environment, and may then be used in that real-world environment. In some implementations each image observation comprises a video frame from a video of the environment.

The demonstration observations may also comprise at least one natural language observation that relates to, e.g. describes, the task that is performed. For example such a natural language observation may be present at or soon after an initial time step. In implementations the demonstration actions characterize actions of the demonstrating agent in the environment as the task is performed. The demonstration observations and actions may be provided for each of a plurality of time steps. The demonstrating agent may be, e.g., a human or another machine learning system.

The multimodal demonstration data may be obtained in any convenient manner. For example in some implementations it may be generated by capturing multiple examples of a human performing a particular task after having been given a natural language instruction that describes the task. As one particular example, the multimodal demonstration data may be obtained from a 3D simulated environment in which two embodied avatars act and interact with natural language to cooperatively accomplish tasks e.g. involving object manipulation, navigation, and question answering. The avatars, i.e. agents, which may be controlled by humans, receive image observations and produce motor actions, and also receive language inputs and produce language outputs. This allows them to answer questions, participate in dialog, ask for clarifications, and so forth, which facilitates the action selection neural network system 110 learning to do the same.

An example of generating data in this way is described in arXiv: 2112.03762, Abramson et al., “Creating Multimodal Interactive Agents with Imitation and Self-Supervised Learning”, 2022, to which reference may be made for details; further material can be found in arXiv: 2012.05672v2, Interactive Agents Group 2020. The approach in Abramson et al. refers to a simulated environment but can also be used in the real-world. The simulated environment may be a simulation or representation of a real world environment and the captured demonstration data can be used to train the action selection neural network system so that it can afterwards act in the real-world environment that was simulated or represented virtually. In general the techniques described herein improve with larger training datasets and more model parameters, e.g. models with greater than 10⁶ to 10⁸ parameters and/or training datasets with greater than 10³ to 10⁴ hours of training data collected, e.g., using a team of human participants.

The action selection system 100 also includes a training engine 140 that controls training of the system as described below. Again this is not needed after training, although it can be retained in case further training is needed. In general training a neural network system as described herein, such as the action selection system 100, comprises backpropagating gradients of an objective function, e.g. a loss function, to update learnable parameters, e.g. weights, of the neural network system. This may use any appropriate gradient descent optimization algorithm, e.g. Adam or another optimization algorithm.

Once trained the action selection neural network system may be used to perform a requested task. This may comprise receiving a natural language description of the task, and providing an embedding of the natural language description of the task to the action selection neural network system 110 as one or more of the natural language observations, optionally as a “sticky” observation. The action selection neural network system 110 is used to process the embedding of the natural language description of the task, and embeddings of observations 106 of the environment 104 e.g. at successive time steps, to control the agent 102 to select actions, e.g. at the time steps, to perform the requested task in the environment. This can also involve the action selection neural network system 110 generating language at the natural language output 118, e.g. for engaging in dialog with the user about the task.

As previously mentioned some implementations of the system include a local or remote user interface 150. In general the user interface 150 is configured to accept a natural language input, e.g. as typed or spoken text, and can be used to provide natural language observations to the action selection system 100 after training. For example the user interface 150 may be used to request that a task is performed, e.g. by obtaining the natural language description of the task. The user interface 150 can also provide a natural language output. Also or instead a natural language description of a task to be performed may be retrieved from memory or obtained via a communications interface e.g. via a wired or wireless network connection. A natural language output may be provided in a similar way.

In some implementations, but not necessarily, the action selection neural network system 110 comprises a transformer neural network. In general a transformer neural network may be a neural network that has a succession of self-attention neural network layers. A self-attention neural network layer has an attention layer input for each element of the input and is configured to apply an attention mechanism over the attention layer input to generate an attention layer output for each element of the input; there are many possible attention mechanisms that may be used. As an example a query-key-value (QKV) attention operation can be applied, where an input embedding is used to determine a query vector and a set of key-value vector pairs, and an updated embedding comprises a weighted sum of the values, weighted by a similarity function of the query to each respective key. In implementations where the embedding of the image is generated using one or more residual neural network blocks, or e.g. from patches of the image, the embedding may be flattened to provide an input to the transformer neural network.

The transformer neural network may be coupled to a memory such as a recurrent neural network, e.g. a neural network with one or more LSTM (Long Short-Term Memory) neural network layers. The transformer neural network can generate a combined representation of the embeddings of the demonstration observations that can be provided to such a recurrent neural network. The intermediate output 119 may be an internal representation of the action selection neural network system, e.g. from an output of the transformer neural network. One or more outputs from the recurrent neural network may then be processed to generate the action selection policy output and the language policy output, e.g. using an action selection policy head and a language policy head.

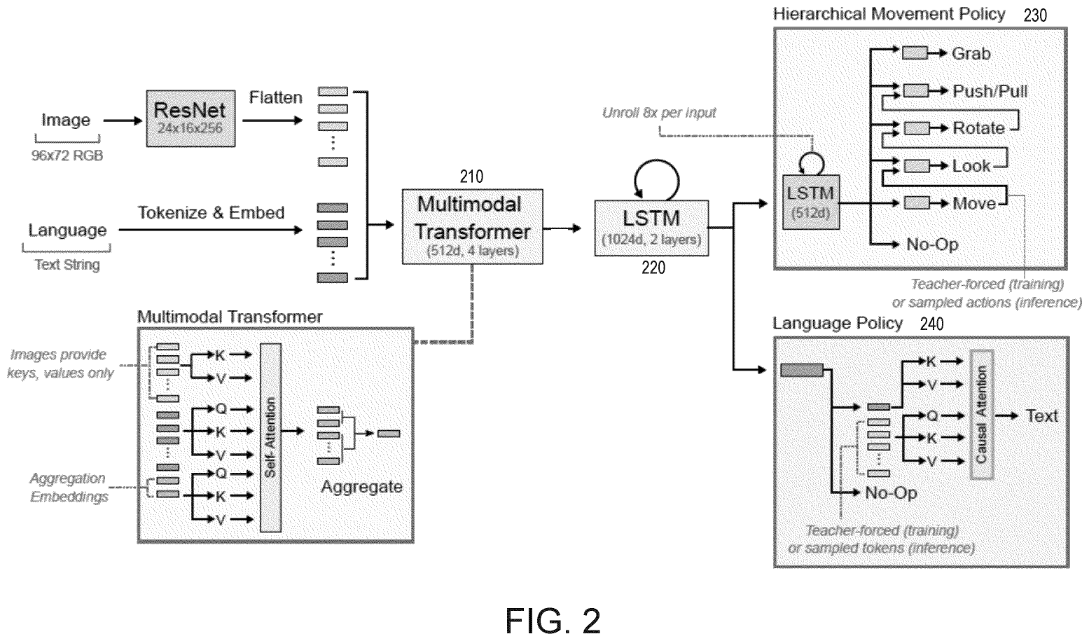

FIG. 2 shows a particular example implementation of an action selection neural network system suitable for use as the action selection neural network system 110 of FIG. 1. In the particular example of FIG. 2 a multimodal transformer neural network 210 processes image and language embeddings to generate an output that is provided as an input to an LSTM memory 220, the output of which conditions an action selection policy head 230 and a language policy head 240. The language embeddings can include one or more aggregation (“CLS”) embeddings that comprise an aggregate representation of an input sentence. In some implementations the image embeddings provide just keys and values for the transformer neural network 210 whilst the language embeddings provide queries, keys, and values. The output of the multimodal transformer neural network 210 can be used as the combined representation of the natural language caption and the image observation for the intermediate output 119.

The example illustrated in FIG. 2 implements hierarchical control in which new observations arrive every n internal time steps and a second LSTM in the action selection policy head 230 unrolls for n time steps, selecting an action at each of these time steps. A language action is emitted every n internal time steps, generated using a second transformer neural network in the language policy head 240, sampling one token at a time, e.g. using the same vocabulary as the natural language input, up to a maximum number of tokens. In a variant of the implementation of FIG. 2 non-hierarchical control is used.

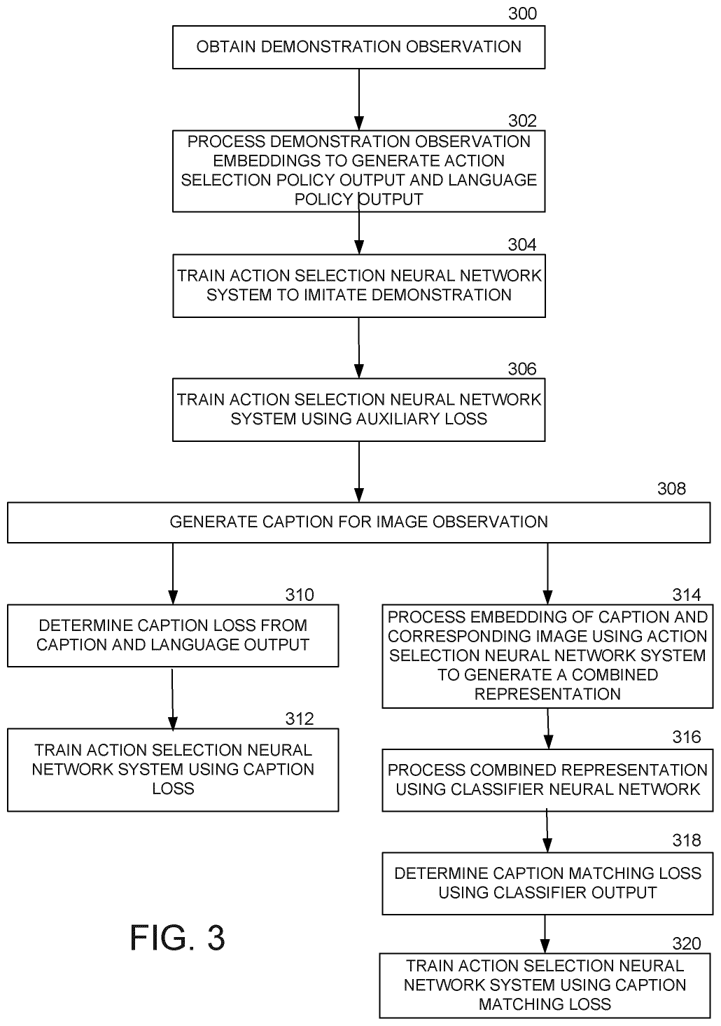

FIG. 3 is a flow diagram of an example process for training an action selection system, e.g. the action selection system 100 of FIG. 1. The process of FIG. 3 may be implemented by one or more computers in one or more locations. In general the process of FIG. 3 is performed for each of a plurality of training steps. The steps of FIG. 3 need not be performed in the order shown.

At step 300 the process obtains, e.g. from demonstration data store 160, a demonstration observation comprising an image observation and a natural language observation; and a demonstration action.

The action selection neural network system 110 processes an embedding of the image observation input and an embedding of the natural language observation to generate the action selection policy output 112 and the language policy output 116 for the demonstration observation (step 302).

In general the process trains the action selection neural network system 110 such that actions selected using the action selection policy output 112 are encouraged to match the actions of the demonstrating agent (step 304). This may be done using an imitation learning technique. For example the training may comprise one or more of: behavioral cloning, inverse reinforcement learning, and Generative Adversarial Imitation Learning (GAIL, arXiv: 1606.03476, Ho et al.). In implementations training the system such that actions selected using the action selection policy output 112 are encouraged to match the actions of the demonstrating agent may simply involve encouraging the action selection policy of the action selection neural network system 110 to select similar states of the environment to those defined by the demonstration observations.

The training may be performed offline, i.e. based solely on the demonstration data, or also online, fining tune the actions selected using reinforcement learning, e.g. by using the agent 102 to act in the environment 104 and in response receiving rewards that are used to train the system, e.g. from a reward model based on human feedback. The action selection neural network system 110 may be trained to optimize an objective function that depends on a difference between a distribution of actions defined by the action selection policy output 112 and a distribution of actions defined by the actions of the demonstrating agent.

In general the training also uses the language from the natural language output 118. As one example the action selection neural network system 110 can be trained so that natural language outputs defined by the language policy output 116 for the demonstration observations are encouraged to match natural language observations in the demonstration observations (which may include dialog, e.g. about a task being performed). This can help associate visual and linguistic representations in the action selection neural network system 110. Also or instead the action selection neural network system 110 can be trained so that natural language outputs defined by the language policy output 116 for the demonstration observations are encouraged to match natural language captions generated for image observations of the demonstration observations.

As one particular example, the action selection neural network system 110 may be trained to minimize a behavior cloning loss, L_{BC}. The behavior cloning loss, L_{BC} may be evaluated for a batch of B trajectories of demonstration observations sampled from the demonstration data store 160 and, where the action selection neural network system 110 includes a recurrent neural network, over a K-step unroll, i.e. with K steps of backpropagation-through-time. For example the behavior cloning loss may be determined as:

$${L}_{B C} = - \frac{1}{B} {\sum }_{b = 1}^{B} {\sum }_{t = 0}^{K} [ ln {π}_{m} ( {a}_{b , t}^{m} \vert {o}_{b , \leq t} ) + ln {π}_{l} ( {a}_{b , t}^{l} \vert {o}_{b , \leq t} ) ]$$

Here πₘ (α|o) refers to the action (movement) selection policy defined by the action selection policy output 112, which defines a probability of each movement action am given an observation o; and o_{≤t} denotes a trajectory of observations leading up to and including oₜ, the demonstration observation at time t (in implementations including a recurrent neural network the action at a time step depends on the current and previous observations). The second term in L_{BC} depends on the language policy πₗ (α|o) defined by the language policy output 116 and selected language actions α^{l}, and is included where the system is also trained using behavior cloning based on the language observations.

In general the process involves training the action selection neural network system 110 using an auxiliary loss based upon the natural language captions from the image captioning neural network system 120 (step 306). The natural language observations in the demonstration observations may be relatively sparse and the captions can provide an additional source of language for training the system. In some implementations the image captioning neural network system 120 has already been trained. In some other implementations the captioning neural network system 120 can be trained in parallel with the action selection neural network system 110. Any image captioning neural network system may be used; a particular example of an image captioning neural network system 120 that may be used is described later.

The auxiliary loss may include a loss that is dependent upon a difference between the natural language output 118 from the action selection neural network system 110 and a caption generated by the image captioning neural network system 120 (a “caption loss”). Also or instead the auxiliary loss may include a loss dependent upon intermediate output 119 from the action selection neural network system 110, in particular dependent on the classifier output 132, when the action selection neural network system 110 processes an embedding of the caption (a “caption matching loss”). The caption loss is used to train the system to “speak” about what it sees; the caption matching loss is used to train the system's language encoding by means of linguistic inputs.

In some implementations the process generates a natural language caption for an image observation in a demonstration observation, using the image captioning neural network system 120 (step 308). The demonstration observation may, but need not be, the demonstration observation processed at step 302. In implementations of the process captions can be generated for more of the image observations than have corresponding natural language observations, thus increasing the amount of language training data available to the system.

The process determines a caption loss that depends on (a metric of) a difference between the natural language caption generated for the image observation and the natural language output from the action selection neural network system 110 for the demonstration observation (step 310). That is, the action selection neural network system 110 processes the image observation of the demonstration observation to generate the language policy output 116 that in turn defines the language output 118 used to determine the caption loss. The action selection neural network system 110 is trained using the caption loss (step 312).

As one particular example the caption loss, L_{C}, may be determined as:

$${L}_{C} = - \frac{1}{B} {\sum }_{b = 1}^{B} {\sum }_{t = 0}^{K} ln {π}_{l} ( {y}_{b , t}^{c} \vert {o}_{b , \leq t} )$$

where y_{b,t}^{c} is the natural language caption for the image observation in the demonstration observation at time t, oₜ and for the bth trajectory of demonstration observations. In implementations the demonstration observation, oₜ, processed by the action selection neural network system 110 to generate the language policy output 116 defining ln πₗ (·|o_{b,≤t}) comprises both the image observation and the natural language observation. The caption loss L_{C} can be understood as a behavior cloning loss between the caption y_{b}^{c} and the language policy πₗ (α^{l}|o) defined by language policy output 116 for the image observation, where α^{l} is the selected language action. The caption loss encourages the natural language output for the image observation, from the action selection neural network system 110, to match the natural language caption for the image observation.

In such implementations, sometimes the natural language output from the action selection neural network system is being trained to match the caption, i.e. the action selection neural network system 110 is being trained to speak about what it sees, and sometimes the action selection neural network system 110 is being trained to reproduce the natural language input in the demonstration observation, i.e. for the purpose of interactive behavior.

Optionally an indicator variable may be used to facilitate the system distinguishing between these tasks, i.e. to indicate whether (or nor) the caption loss is to be used for training. The action selection neural network system 110, e.g. a language policy head of the action selection neural network system, can receive a corresponding binary indicator or flag embedding as input. For example the input of the language policy can be summed with a learnable embedding of the indicator variable representing whether the target is captioning or language output from a demonstration.

In some implementations training the action selection neural network system using the natural language captions also or instead involves determining a caption matching loss. This may comprise processing an embedding of the natural language caption generated for the image observation of a demonstration observation, and an embedding of the image observation (of the demonstration observation), using the action selection neural network system 110, to generate a combined representation of the natural language caption and the image observation at the intermediate output 119 (step 314).

The combined representation is processed by the classifier neural network 130 to generate the classifier output 132. This predicts whether (or not) the natural language caption and the image observation match (step 316).

A value of a caption matching loss is then determined using the classifier output 132 (step 318), and the action selection neural network system 110 is trained using the caption matching loss (step 320). The caption matching loss may comprise or depend on the classifier output. In some implementations the caption matching loss is determined by processing a batch of image observations one of which corresponds to the natural language caption. Then the caption matching loss may comprise a sum, for each image of the batch, of a first term that represents a probability that the image observation and natural language caption are paired, and a second term that represents a probability that a probability that the image observation and natural language caption are unpaired. For example, the first term may be determined from the classifier output when the action selection neural network system 110 processes embeddings of a paired, i.e. matching, caption and image observation. The second term may be determined from the classifier output when the caption and image observation are unpaired i.e. when the caption does not match, i.e. correspond to, the image observation. The action selection neural network system 110, and in implementations the classifier neural network 130, may be trained using the caption matching loss.

As one particular example, the caption matching loss, L_{CM}, may be determined as:

$${L}_{CM} = - \frac{1}{B} {\sum }_{b = 1}^{B} {\sum }_{t = 0}^{K} [ ln D ( {o}_{b , t}^{X} , {y}_{b , t}^{c} ) + ln ( 1 - D ( {o}_{b , t}^{X} , {y}_{roll ( b ) , t}^{c} ) ) ]$$

where o_{b,t}^{x} denotes the image observation part of the demonstration observation, oₜ for the bth trajectory of demonstration observations in the batch and y_{b,t}^{c} is the natural language caption as previously. D (·) denotes the classifier output 132, which is determined from the intermediate output 119 of the action selection neural network system 110 when the action selection neural network system processes an embedding of the natural language caption and an embedding of the corresponding image observation. In L_{CM}, y_{roll(b),t}^{c} denotes a natural language caption that does not match the image observation o_{b,t}^{X}. In implementations y_{roll(b),t}^{c} represents a caption from another batch of demonstration observations, for example selected according to a roll function roll (b)= (b+1) mod B.

In implementations the classifier neural network and the action selection neural network system 110 are trained in a separate training pass. That is, steps 314 to 320 of the process may be performed separately to step 304. In implementations the total effective loss for the system includes a sum of the above losses, i.e. L_{BC}+L_{C}+L_{CM}.

As described above, in general the image captioning neural network system 120 processes an image observation in one of the demonstration observations to generate a natural language caption for the image observation. In this way, as the action selection neural network system 110 is trained using the demonstration observations it learns to generalize its training to objects that it has not specifically interacted with but that are present in an image observation, and captioned, i.e. described as present to the system. In some implementations the particular information in a caption can be tailored to the tasks to be performed. For example if object color is important to a task then the captions can be arranged to describe the color of objects present. A caption need not describe every object in an image, and typically the image captioning neural network system 120 will generate different captions when used repeatedly to process the same or similar image observations. In one example implementation the image captioning neural network system 120 described, on average, 1.2 objects out of ˜13 objects per image.

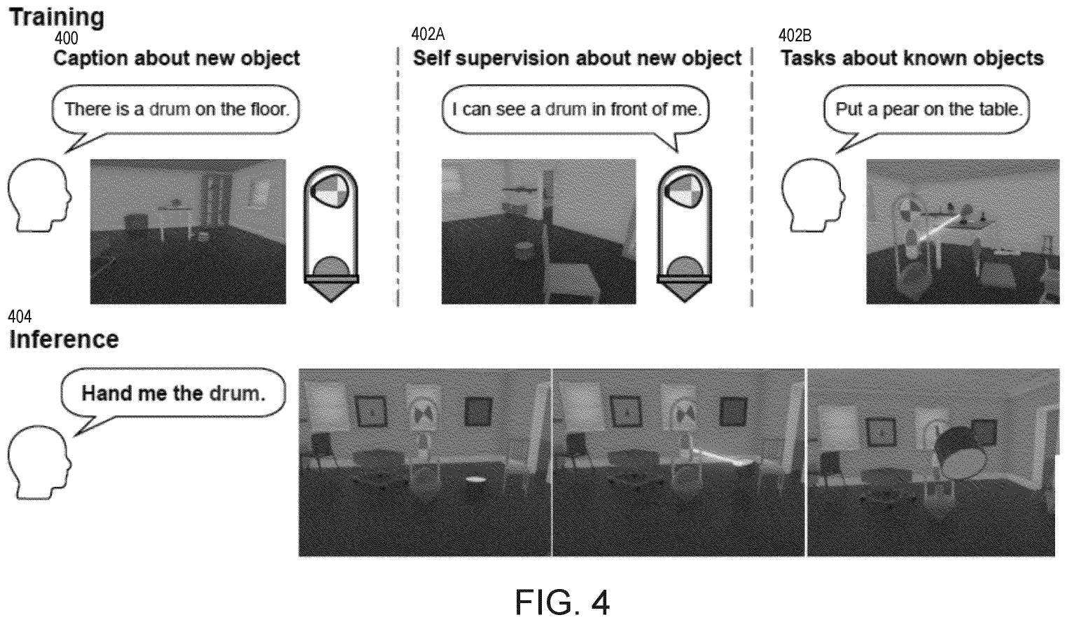

FIG. 4 illustrates an example implementation of the training process of FIG. 3, also showing the action selection neural network system used in inference. At optional stage 400 the image captioning neural network system 120 is trained to caption images, in the illustrated example describing a “new” object, a drum. At stage 402B the action selection system 100 learns to perform a task that involves interacting with an object described in one or more natural language observations in the demonstration data (a pear). Whilst learning in this way the system also learns, using self-supervision as described above, to generate captions for the image observations in the demonstration data (stage 402A). In the example the caption for the image observation describes a drum, but a drum is not mentioned in the natural language observations in the demonstration data. Despite this, as shown in stage 404, after training as described the action selection system is able to perform a task that involves the drum.

The image captioning neural network system 120 may be any pre-trained image captioning system, or an image captioning neural network system for use in the system can be trained conventionally, e.g. using supervised training based on labelled training data, i.e. examples of images and their associated captions.

Conveniently the image captioning neural network system 120 can be trained using the demonstration observations, but typically there are more image observations without corresponding natural language observations than image observations with corresponding natural language observations. Thus there is also described a technique for semi-supervised training of an image captioning neural network system, such as image captioning neural network system 120, using a reduced the amount of labelled training data.

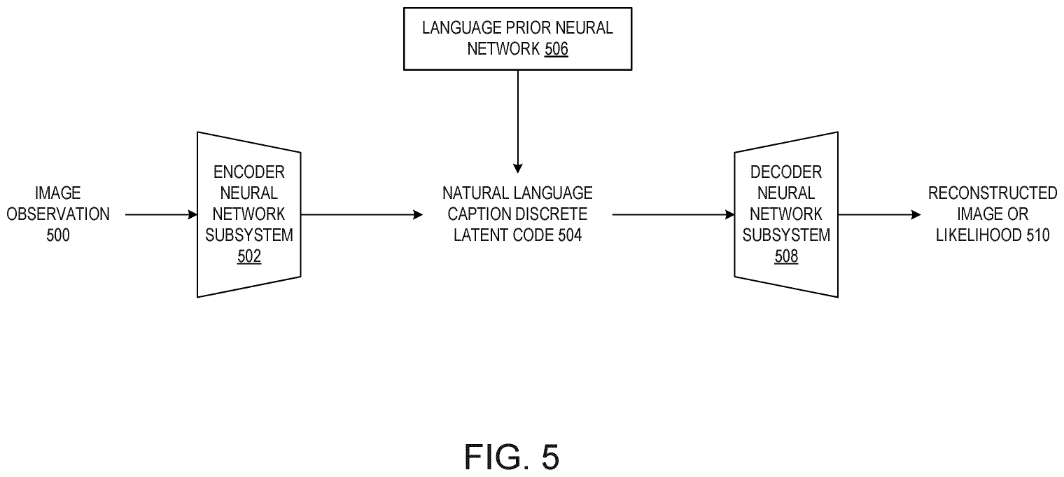

FIG. 5 shows a system for training an image captioning neural network system such as image captioning neural network system 120. The system comprises an encoder neural network subsystem 502, a decoder neural network subsystem 508, and a language prior neural network 506. After training the encoder neural network subsystem 502 is used as the image captioning neural network system.

The encoder neural network subsystem 502 is configured to process an image observation to generate an image caption. The decoder neural network subsystem 508 is configured to process an image caption input to generate a decoder output 510. In some implementations the decoder output 510 defines a reconstruction of an image observation from a corresponding natural language caption for the image, which serves as a discrete latent code 504. In some implementations the decoder output 510 comprises a value that represents a likelihood that a sampled image observation, e.g. sampled from the demonstration data, corresponds to the image observation for the corresponding natural language caption. In these latter implementations the decoder can operate as a discriminator or classifier that, given a particular caption and an image or a set of images, is configured to generate a decoder output value for determining a likelihood that the image, or a particular one of the set of images, corresponds to the particular caption.

During training the encoder neural network subsystem 502 and the decoder neural network subsystem 508 can be partly trained using supervised learning, and partly trained using a variational method that involves either reconstructing an image from its caption or determining a value of a contrastive loss that corresponds to an image reconstruction loss. The variational method uses language as the latent code 504, so that the latent code represents the image as a natural language caption. Thus training using the variational method also involves encouraging the generated image caption to stay close to a language prior that serves as a language model for the caption. The language prior may be generated by a pre-trained language prior neural network 506. Because of the space of latent codes is large and discrete in some implementations the system is trained using reinforcement learning.

The encoder neural network subsystem 502, the language prior neural network 506, and the decoder neural network subsystem 508 may each have any suitable neural network architecture and may include, e.g., one or more feed forward neural network layers, one or more recurrent neural network layers, one or more convolutional neural network layers, one or more attention neural network layers, or one or more normalization layers.

As an example, encoder neural network subsystem 502 may comprise an image embedding neural network, e.g. a ResNet, that has an output that conditions a (causal) transformer neural network configured generate to one or more output language tokens one at a time. Merely as an example, for supervised training language targets can be encoded using a SentencePiece byte-pair encoder (Kudo et al., arXiv: 1808.06226, 2018). As an example, the language prior neural network 506 may comprise a transformer neural network.

Where the decoder neural network subsystem 508 generates an image output from an image caption input the decoder neural network subsystem may have any generative neural network architecture. Merely as one example the decoder neural network subsystem 508 may have a VQ-VAE architecture (van den Oord et al. “Neural discrete representation learning”, Advances in Neural Information Processing Systems, 2017), conditioned on natural language tokens determined from the image caption input. In such an example the VQ-VAE may be pre-trained on the unlabeled images to define the VQ-VAE codebook. The VQ-VAE tokens can then be modelled autoregressively using a first transformer neural network. A second transformer neural network can be used to process an embedding of the language tokens representing the caption input, and the output of this transformer can be cross-attended by the decoder, e.g. by the first transformer neural network. Where the decoder neural network subsystem 508 operates as a discriminator or classifier it may comprise an image representation neural network, e.g. an image embedding neural network as previously described, and/or a language representation neural network, e.g. a language embedding neural network such as a transformer neural network.

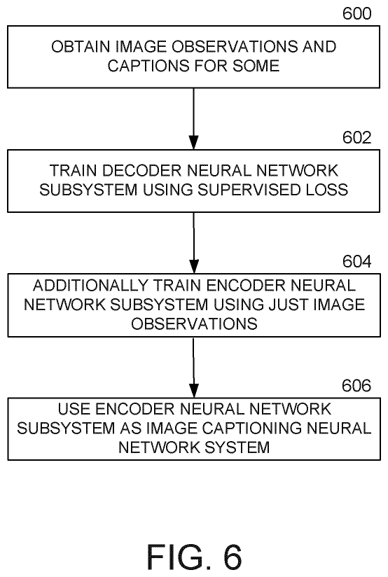

FIG. 6 shows an example process for training an image captioning neural network system such as image captioning neural network system 120. The process of FIG. 6 can be performed independently of training the previously described action selection system 100, to obtain a trained image captioning neural network system that is configured to process a representation of an image to generate a natural language caption output describing the image. The process of FIG. 6 may be implemented by one or more computers in one or more locations. The steps of FIG. 6 need not be performed in the order shown.

At step 600 the process obtains image observations, e.g. from multimodal demonstration data, and obtains image captions for the image observations (where available), to thereby obtain paired data items each pair comprising an image observation and a corresponding image caption. The multimodal demonstration data may be, but need not be, the same data used to train the action selection system 100. For example in some implementations the image captions may be generated by asking humans to provide captions for some of the image observations in the multimodal demonstration data. An advantage of the described training techniques is that captions need only be provided for a small fraction of the images.

At step 602 the decoder neural network subsystem 508 is trained using a supervised loss dependent on the respective decoder output and a ground truth reference derived from the paired data items.

Where the decoder output 510 defines a reconstruction of an image observation the ground truth reference may be the image observation that was reconstructed. The decoder output for a paired data item may be generated by processing the corresponding natural language caption from the paired data item, using the decoder neural network subsystem 508, to generate a decoder output that defines the reconstruction of the image observation. The ground truth reference derived from the paired data items may comprise the image observation for the corresponding image caption.

Training the decoder neural network subsystem 508 using the supervised loss may comprise training using a supervised loss function (decoder objective function), that depends on a difference between the reconstruction of the image observation and the image observation for the corresponding image caption. The supervised loss function may be defined as log p_{θ}(x|y), where x represents the image that was reconstructed, y represents the corresponding natural language caption, and p^{θ}(x|y) represents the decoder neural network subsystem 508 with learnable parameters, e.g. weights θ. In practice a value of the supervised loss function may be determined, e.g., as a squared difference between the image and its reconstruction.

Where the decoder output 510 defines the likelihood that an image observation and a natural language caption correspond, the ground truth reference may be the ground truth correspondence between the image and its corresponding image caption. The (ground truth) corresponding image caption may be obtained from a paired data item, or it may have been generated by the encoder neural network subsystem 502.

The encoder neural network subsystem 502 can also be trained using the paired data items. For example encoder neural network subsystem 502 can be trained using a supervised language loss based a difference between an image caption generated from an image observation by the encoder neural network subsystem 502 and an image caption corresponding to the image observation in a paired data item.

At step 604 the encoder neural network subsystem 502, and in implementations also the decoder neural network subsystem 508, is (in addition) trained using just image observations i.e. without relying on a corresponding image caption in a paired data item.

In general this involves imputing, i.e. inferring, an image caption for an image observation (which may be one that is not paired with a corresponding image caption) by processing the image observation using the encoder neural network subsystem to generate an imputed image caption. The imputed image caption is processed by the decoder neural network subsystem to determine an objective value, i.e. the value of an objective function, dependent upon the decoder output for the imputed image caption. This is used for training the encoder neural network subsystem 502, and in implementations also the decoder neural network subsystem 508. For example the value of the objective function may define a lower bound on a likelihood of a reconstructed image or of a likelihood that an image observation, or a particular one of a set of image observations, corresponds to the imputed image caption. The value of the objective function may then be maximized, or a negative of this may be minimized.

In some implementations the objective function has a first term dependent on a likelihood of a decoded image, x, generated by processing the imputed image caption, y, using the decoder neural network subsystem 508, e.g. log p_{θ}(x|y). It may also have a second, regularization term representing a difference between a distribution of the imputed image captions generated by the encoder neural network subsystem 502, q_{ω}(y|x), where w denotes the learnable parameters of the encoder neural network subsystem, and a distribution that defines a, fixed, e.g. pre-trained, prior probability of the image captions, p_{ϕ}(y), where ϕ denotes the learnable parameters of the language prior neural network. The (fixed) distribution that defines the prior probability may be generated, e.g. by training the language prior neural network 506 using the natural language observations in the demonstration data. The difference may comprise a measure of KL (Kullback-Leibler) divergence, D_{KL} [q_{ω}(y|x)∥p_{ϕ}(y)], and may be stochastically estimated with a single value, or by sampling multiple (unpaired) image observations, x, and determining an average. In some implementations the objective function, Jᵤ, may be determined as

$${J}_{u} = log {p}_{θ} ( x \vert y ) - {D}_{K L} [ {q}_{ω} ( y \vert x ) ‖ {p}_{ϕ} ( y ) ]$$

where in practice log p_{θ}(x|y) may be determined directly, i.e. as a predicted log likelihood (e.g. of discrete tokens e.g. generated by the VQ-VAE). The encoder neural network subsystem 502 and, optionally the decoder neural network subsystem 508, may be trained to maximize Jᵤ. A gradient of Jᵤ with respect to the learnable parameters of the encoder neural network subsystem 502, ∇_{ω}Jᵤ, can be determined as:

$${∇}_{ω} {J}_{u} = {∇}_{ω} log {q}_{ω} ( y \vert x ) [ log {p}_{θ} ( x \vert y ) + log {p}_{ϕ} ( y ) - log {q}_{ω} ( y \vert x ) ]$$

and an estimate of this may be determined, e.g. by stochastically sampling from q_{ω} (y|x), by sampling one or more (unpaired) image observations.

The space of natural language captions, i.e. discrete latent codes, is large. In some implementations the value of the objective function can be maximized using reinforcement learning, based on a reward that corresponds to the value of the objective function.

Processing an image observation using the encoder neural network subsystem 502 to generate an imputed image caption implicitly defines a caption determination policy, e.g. q_{ω}(y|x) can be taken as the caption determination policy. Using reinforcement learning to update the caption determination policy, i.e. parameters of the encoder neural network subsystem can facilitate optimization of Jᵤ.

In implementations the reward depends on an accuracy of the reconstruction of the image observation from the corresponding image caption or the likelihood that the sampled image observation corresponds to the image observation for the corresponding image caption. In implementations the reward also depends on a difference between a distribution of the imputed image captions and a distribution that defines a prior probability of the image captions, e.g. determined by a metric such as KL divergence. For example in some implementations the reward can depend on the first and second terms described above. In some implementations the reward depends on log p_{θ}(x|y)+logp_{ϕ} (y)-log q_{ω} (y|x).

Any reinforcement learning technique may be used to learn the caption determination policy, e.g. one based on temporal-difference learning, or on learning a policy directly e.g. via a policy gradient; or another policy optimization technique such as MPO (Maximum a Posteriori Policy Optimization, Abdolmaleki et al., 2018) or PPO (arXiv: 1707.06347), or a variant thereof such as V-MPO (arXiv: 1909.12238 Song et al.).

The encoder neural network subsystem 502 can be used for the image captioning neural network system 120, either after it has been trained or whilst it is being trained (step 606). That is, the encoder neural network subsystem may be trained whilst also training the action selection system 110.

In some implementations the decoder neural network subsystem 508 comprises an image classifier neural network subsystem. The decoder output 510 may then define a value representing a likelihood that a sampled image observation, sampled from the multimodal demonstration data, corresponds to the image observation for the corresponding image caption. The ground truth reference derived from the paired data items may define when the sampled image observation corresponds to ground truth in this way, e.g. because it is either the image observation for the corresponding image caption or an image from which the corresponding image caption was generated using the encoder neural network subsystem. The generative reconstruction loss log p_{θ}(x|y) is proportional to such a likelihood (up to constant factors with respect to y) and thus such a likelihood can be used in place of the previously described generative reconstruction loss, e.g. log p_{θ}(x|y). This has an advantage of reducing the complexity of the system as it can be easier to implement (and train) a classifier than a generative neural network to generate an image output.

Training the image captioning neural network system may then comprise obtaining a batch of image observations from the multimodal demonstration data, and obtaining a caption for a selected image observation in the batch either from the multimodal demonstration data or by processing the selected image observation using the encoder neural network subsystem. In some implementations the batch may comprise a caption for each image observation in the batch, but only one image observation-caption pair may match.

A value of a contrastive loss function may then be determined. In implementations the contrastive loss function comprises a combination of a likelihood that the selected image observation corresponds to the obtained caption and a likelihood that the other image observations in the batch do not correspond to the obtained caption, e.g. a cross-entropy loss.

The selected image observation image observation may be processed using the encoder neural network subsystem to generate the imputed image caption. The objective value dependent upon the decoder output for the imputed image caption may be dependent upon the value of the contrastive loss function.

In implementations, where the batch comprises a caption for each image observation, the contrastive loss function may be symmetrized by combining, e.g. summing, a first loss derived from matching each image in the batch to the corresponding caption in the batch, and a second loss derived from matching each caption in the batch to the corresponding image observation.

As a particular example, for a multi-class classifier that discriminates whether a batch element yᵢ is paired with a batch element xi, with a cross-entropy loss for the correct index c=j given by L ({x_{b}}_{b=1}^{B},>yᵢ, C=j), log p_{θ}(x|y) is proportional to L ({x_{b}}_{b=1}^{B}>yᵢ, c=j) up to constant factors with respect to y. Thus for batch element j this value can be used instead of log p_{θ}(xⱼ|yⱼ) in the above expression for ∇_{ω}Jᵤ and the gradients with respect to ω remain the same in expectation i.e. on average.

The image classifier neural network subsystem may comprise an image representation neural network, e.g. a ResNet or other image processing neural network, configured to process a sampled image observation to generate a representation of the sampled image observation, e.g. as an image vector. The image classifier neural network subsystem may also comprise a caption representation neural network, e.g. a transformer neural network, e.g. followed by an MLP (multi-layer perceptron), configured to process a corresponding image caption to generate a representation of the corresponding image caption, e.g. as a caption vector. The decoder output may be determined by determining a similarity between the representation of the sampled image observation and the representation of the corresponding image caption, e.g. by determining a dot product or other similarity measure between the image vector and the caption vector.

Continuing the previous particular example, and denoting the image representation neural network as f (x) and the caption representation neural network as g (y), in some implementations a contrastive loss function for the classifier comprises a sum of two losses, one for matching each image to its paired caption in the batch and one for matching each caption to its paired image:

$$L = \frac{1}{B} {\sum }_{j = 1}^{B} log \frac{{e}^{{f ( {x}_{j} )}^{T} g ( {y}_{j} )}}{{\sum }_{b = 1}^{B} {e}^{{f ( {x}_{b} )}^{T} g ( {y}_{j} )}} + \frac{1}{B} {\sum }_{j = 1}^{B} log \frac{{e}^{{f ( {x}_{j} )}^{T} g ( {y}_{j} )}}{{\sum }_{b = 1}^{B} {e}^{{f ( {x}_{j} )}^{T} g ( {y}_{b} )}}$$

The image classifier neural network subsystem can be trained by minimizing L, e.g. whilst also training the encoder neural network subsystem 502. In some implementations samples from q_{ω}(y|x) may be included as positive, i.e. paired, examples for the classifier as well as those in the multimodal demonstration data.

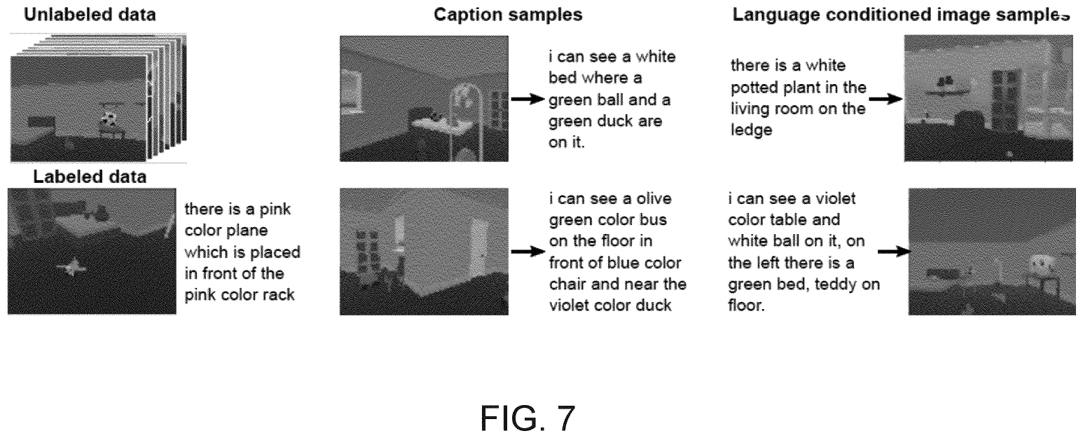

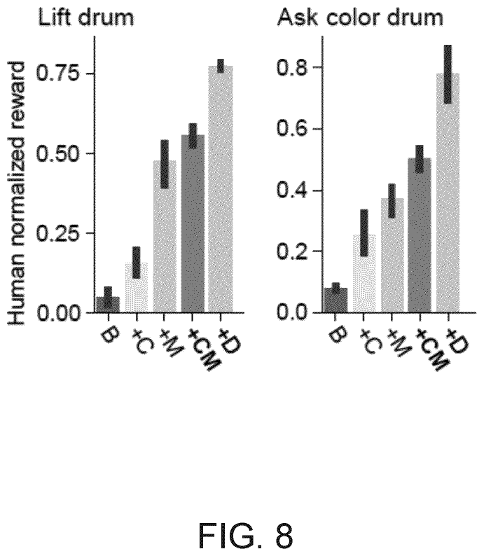

FIG. 7 illustrates operation of the system of FIG. 5. A large corpus of unlabeled images together with a relatively small number of images labelled with captions can be used to train the system so that the trained encoder neural network subsystem 502 can generate captions as illustrated. Optionally, in implementations where the decoder neural network subsystem 508 comprises a generative model, the trained decoder neural network subsystem 508 can be used to generate images, from a distribution corresponding to that of the training data, from a caption, i.e. from a description of the image to be generated. FIG. 8 illustrates the performance of an example implementation of the system of FIG. 1 after training. FIG. 8 shows two tasks relating to a “drum” object, “Lift drum” and “Ask color drum”; the y-axis represents relative performance on the tasks, in particular a reward normalized to human performance. The bars labelled “B” relate to a baseline system without an auxiliary loss and trained on demonstration data without any drum-based interactions. The bars labelled “D” are for a system trained using drum-based instruction and interactions in the demonstration data (an expected upper-bound for performance). The bars labelled “C”, “M” and “CM” are for implementations of the described system with, respectively, a caption loss, a caption matching loss, and both these losses, and trained on demonstration data without any drum-based interactions (but with some image observations including a drum). It can be seen that implementations of the system can perform tasks involving a drum without having explicitly been trained to interact with a drum, instead generalizing from other trained tasks.

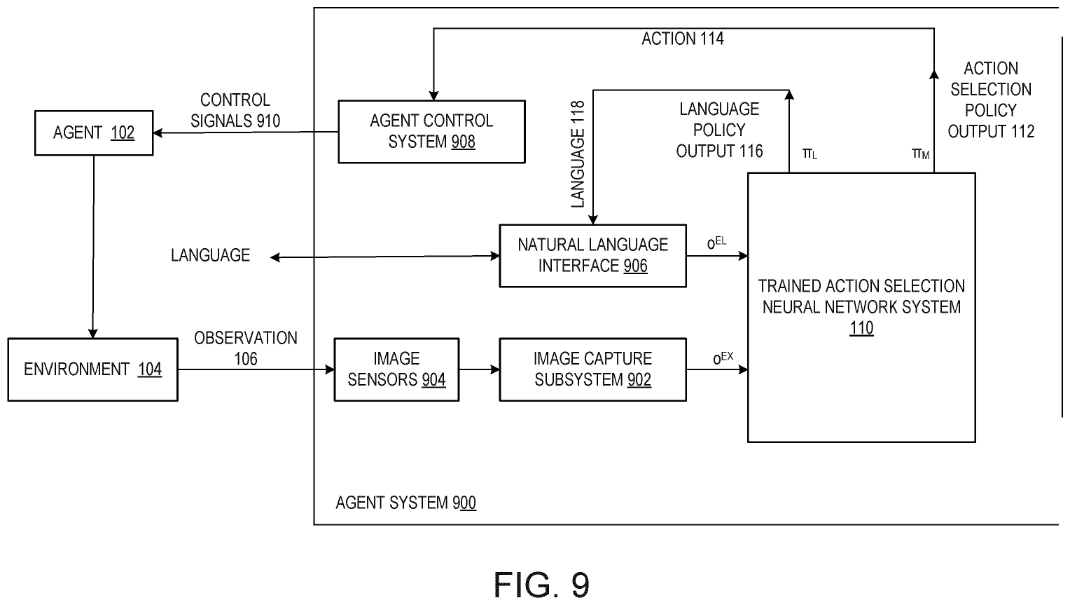

FIG. 9 shows an example of an agent system 900 configured to control an agent 102, e.g. the agent 102 of FIG. 1, to select actions to perform tasks in an environment. The agent system 900 may be implemented as one or more computer programs on one or more computers in one or more locations. In some implementations the agent 102 may include the agent system 900.

The agent system 900 includes an image capture subsystem 902 to capture image observations of the environment at a succession of time steps. In a real-world environment the image capture subsystem may receive a signal from one or more image sensors 904, configured to capture image observations of the environment. The agent system 900 includes a local or remote natural language interface 906 to receive a natural language input, e.g. a description of a task to be performed. As an example, the task may involve manipulating or moving an object defined by the natural language description of the task. The natural language interface 906 can also provide a natural language output, e.g. to facilitate dialog with a user about the task.

The agent system 900 also includes a trained action selection neural network system 110, e.g. trained as described above. The action selection neural network system may be local to or remote from the mechanical agent, e.g. onboard on the agent or partly or wholly implemented on a remote server. The action selection neural network system 110 is configured to process an embedding of an observation input at a time step to generate an action selection policy output 112, for selecting an action 114 at the time step for the agent 102 to perform the task. In implementations the action selection neural network system 110 is further configured to generate a language policy output 116 for defining a natural language output 118 at the time step. The embedding of the observation input at a time step comprises an embedding of an image of the environment from the image capture subsystem 902 and an embedding of a natural language input from the natural language interface 906.

The agent system 900 also includes an agent control system 908 to control the agent in accordance with the selected actions to perform the task. The agent control system may be coupled to the action selection policy output to provide control signals 910 in accordance with the selected actions. For example, where the agent comprises a mechanical agent with one or more electromechanical devices to control movement or locomotion of the mechanical agent in a real-world environment, the control signals may control the electromechanical device(s) to perform the task.

In general the natural language output at a time step relates to the environment, more specifically to the task performed in the environment, and may comprise e.g. a natural language description of the environment at the time step, e.g. of the or another agent, or relating to one or more objects in the environment; or dialog in relation to the task or environment. In implementations, for at least one of the time steps the embedding of the natural language input comprises an embedding of the natural language description of the task.

Optionally the agent system 900 can include the image captioning neural network system 120, and optionally also the classifier neural network 130. The agent system 900 can include a training engine, e.g. the training engine 140, to further train the action selection neural network system 110, e.g. as previously described and/or using reinforcement learning. For example it may be useful for the agent to be able to continue training, e.g. when moved from one environment to another, e.g. when a household robot is trained in one house and moved to another.

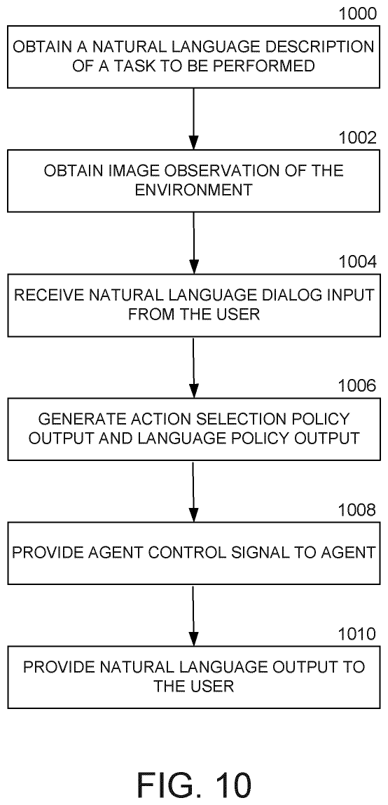

FIG. 10 shows an example process for controlling an agent to select actions to perform a task in an environment, e.g. using the agent system 900. The process of FIG. 10 may be implemented by one or more computers in one or more locations. The steps of FIG. 10 need not be performed in the order shown.

In implementations the process obtains a natural language observation comprising a natural language description of the task to be performed, e.g. via a local or remote user interface, e.g. as written text or from spoken input processed by a speech recognition system (step 1000).

At each of a succession of time steps the process can capture an image observation of the environment that characterizes a state of the environment (step 1002).

At one or more of the time steps a user natural language observation (dialog input) may be received from the user, e.g. via the user interface. For example the user natural language observation may comprise user-turn dialog relating to the task (step 1004).

At each time step an embedding of an observation including the image observation is processed, using a trained action selection neural network system, e.g. one trained as described above, to generate an action selection policy output for selecting an action at the time step for the agent to perform the task (step 1006). The trained action selection neural network system can also generate a language policy output for defining a natural language output at the time step. In general the natural language output relates to the observation and the task, e.g. it can describe the observation as it relates to the task, describe the environment in relation to the agent, e.g. describing movement of an object or the agent, or it can comprise dialog in relation to the task, e.g. answering a user question.

The trained action selection neural network system may comprise a transformer neural network coupled to a recurrent neural network. Processing the embedding of the image observation and the embedding of the user natural language observation may comprise using the transformer neural network to generate a combined representation of the embeddings, and then processing the combined representation using a recurrent neural network to generate the action selection policy output and the language policy output.

For one or more of the time steps, e.g. at an initial time step an optionally at one or more time steps after the initial time step, the observation can include the natural language observation comprising the natural language description of the task to be performed. Then an embedding of the image observation and an embedding of the natural language observation are processed by the trained action selection neural network system.

Where the user natural language observation comprises user-turn dialog relating to the task an embedding of the image observation and an embedding of the user natural language observation may be processed by the trained action selection neural network system to generate the action selection policy output and the language policy output. Then the language policy output can define a machine-turn dialog natural language output responding to the user-turn dialog that is provided to the user.

A control signal is provided to the agent in accordance with the selected action for controlling the agent to perform the selected action (step 1008). Any type of agent control interface may be used appropriate to the agent (examples of agents are described later). For example the control signal may comprise an electrical control signal and/or data for processing by a computer system of the agent.

The natural language output is provided to a user, e.g. via the user interface, e.g. in text or spoken form (step 1010). This can include providing the machine-turn dialog natural language output to the user.

For illustrative purposes, a small number of example implementations are described below.

In some implementations the agent is a mechanical agent acting in the real-world environment to perform a task. The image observations are from one or more image sensors, e.g. video cameras, sensing the real-world environment. The action selection neural network system 110 is configured to process embeddings of the image observations and an embedding of the natural language description of the task to generate the action selection policy output for selecting actions for controlling the agent to perform the task.

In some implementations the action selection neural network system is trained using a simulation of a mechanical agent in a simulation of a real-world environment, in order for the action selection neural network system then to be used to control the mechanical agent in the real-world environment. The observations may relate to the real-world environment in the sense that they are observations of the simulation of the real-world environment. The actions may relate to actions to be performed by the mechanical agent acting in the real-world environment to perform the task in the sense that they are simulations of actions that will later be performed in the real-world environment. After the action selection neural network system has been trained to perform a task in simulation it can be used to control the mechanical agent to act the real-world environment to perform the or another task.

In more detail, where the environment is a real-world environment the agent may be a mechanical agent interacting with the real-world environment, such as a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment, or to manipulate a specified object, or to move a specified object to a specified location in the environment, or to navigate to a specified destination in the environment. The object, location, or destination may be specified by a natural language instruction as previously described.

The observations include images or video data, for example from a camera or other image sensor e.g. a LIDAR sensor (herein an “image” includes a point cloud). The camera or other image sensor may be mounted on the agent or located separately from the agent in the environment. The observations may also include other sensor data such as object position data, data from a distance or position sensor, data from an actuator, or sensed electronic signals such as motor current or a temperature signal. In the case of a robot the observations may also include data characterizing the current state of the robot, e.g., one or more of: joint position, joint velocity, joint force, torque or acceleration, e.g., gravity-compensated torque feedback, and global or relative pose of an item held by the robot or of one or more parts of the agent. Optionally, in any of the described implementations the observation at any given time step may include data from a previous time step that may be beneficial in characterizing the environment.

The actions may comprise control signals to control the robot or other mechanical agent, e.g., torques for the joints of the robot or torques to a control surface or other control elements e.g. steering control elements of a vehicle, or higher-level control commands. The control signals can include for example, position, velocity, or force, torque, or acceleration data for one or more joints of a robot or parts of another mechanical agent. The control signals may also or instead include electronic control data such as motor control data or, for a vehicle, signal to control navigation, e.g., steering, and movement, e.g., braking and/or acceleration of the vehicle.

As previously described, the environment may be a simulation of a particular real-world environment, and the agent may be implemented as one or more computers interacting with the simulated environment. For example, the simulated environment may be a simulation of a robot or vehicle and the system may be trained on the simulation and then, once trained, used in the particular or a similar real-world environment for controlling a real-world mechanical agent. This can avoid unnecessary wear and tear on and damage to the real-world environment or real-world agent and can allow the control neural network to be trained and evaluated on situations that occur rarely or are difficult to re-create in the real-world environment. In some cases the system may be partly trained using a simulation as described above then further trained in the real-world environment. Generally in the case of a simulated environment the observations may include simulated versions of one or more of the previously described observations or types of observations and the actions may include simulated versions of one or more of the previously described actions or types of actions.

In some applications the real-world environment is a manufacturing environment for manufacturing a product, such as a chemical, biological, or mechanical product, or a food product (which, as used herein, includes manufacture of a food product by a kitchen robot). Then the mechanical agent can be a machine such as a robot, that operates to manufacture the product or a part thereof, or a machine that controls movement of an intermediate version or component of a product between manufacturing units. The task can be, e.g., any type of task relating to the manufacture of a product or an intermediate version or component thereof, including a control task, e.g. to minimize, use of a resource such as a task to control electrical power consumption, or water consumption, or the consumption of any material or consumable used in the manufacturing process, or to optimize a quality of the product. Such environments can include chemical synthesis, e.g. protein or drug synthesis environments where the product is a chemical, e.g. a protein or drug, or an intermediate or component thereof.

In some applications the real-world environment is a facility in which electrical power or water is generated or used, the mechanical agent comprises a machine, and the task is to control the generation or use of electricity or water. For example the mechanical agent can be a machine that controls the delivery of electrical power or the configuration of one or more renewable power generating elements e.g. the configuration of a wind turbine or solar panels or mirrors, or the configuration of a rotating electrical power generation machine.

In the above applications the control signals can be any control signals appropriate to the type of machine that is controlled.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method of training an action selection neural network system to control an agent to select actions to perform a task in an environment,
wherein the action selection neural network system is configured to process an embedding of an observation, comprising an embedding of an image of the environment and an embedding of a natural language input, to generate an action selection policy output for selecting an action to be performed by the agent and a language policy output for generating a natural language output;
the method comprising:
obtaining multimodal demonstration data comprising a plurality of task demonstration sequences, each task demonstration sequence comprising a sequence of demonstration observations and demonstration actions,
wherein the demonstration observations comprise image observations that characterize states of the environment while a demonstrating agent interacts with the environment to perform a task, and at least one natural language observation that describes the task that is performed, and wherein the demonstration actions characterize actions of the demonstrating agent in the environment as the task is performed;
processing embeddings of the demonstration observations using the action selection neural network system to generate the action selection policy output and the language policy output for the demonstration observations; and
training the action selection neural network system, using a natural language output defined by the language policy output, such that actions defined by the action selection policy outputs from the action selection neural network system are encouraged to match the actions of the demonstrating agent;
wherein training the action selection neural network system further comprises:
processing the image observations of the demonstration observations using an image captioning neural network system to generate natural language captions for the image observations; and
training the action selection neural network system using the natural language captions.

2. The method of claim 1, comprising:
training the action selection neural network system such that natural language outputs defined by the language policy output for the demonstration observations are encouraged to match natural language observations in the demonstration observations; and
training the action selection neural network system using an auxiliary loss based on the natural language captions.

3. The method of claim 1, wherein training the action selection neural network system using the natural language captions comprises:
determining a caption loss, wherein the caption loss depends on a difference between the natural language caption generated for the image observation of a demonstration observation and the natural language output from the action selection neural network system for the demonstration observation; and
training the action selection neural network system using the caption loss.

4. The method of claim 1, wherein training the action selection neural network system using the natural language captions comprises:
processing an embedding of the natural language caption generated for the image observation of a demonstration observation, and an embedding of the image observation, using the action selection neural network system to generate a combined representation of the natural language caption and the image observation;
processing the combined representation using a classifier neural network to generate a classifier output that predicts whether the natural language caption and the image observation match;
determining a value of a caption matching loss from the classifier output; and
training the action selection neural network system using the caption matching loss.

5. The method of claim 1, wherein the action selection neural network system comprises a transformer neural network coupled to a memory, and wherein generating the action selection policy output and the language policy output comprises:
processing the embeddings of the demonstration observations by processing the embedding of the image of a demonstration observation and the embedding of the natural language description of the demonstration observation using the same transformer neural network to generate a combined representation of the embeddings of the demonstration observations;
providing the combined representation to the memory;
processing one or more outputs from the memory to generate the action selection policy output and the language policy output.

6. The method of any one of claim 5 wherein the memory comprises a recurrent neural network.

7. The method of claim 1, wherein training the action selection neural network system such that actions defined by the action selection policy outputs from the action selection neural network system match the actions of the demonstrating agent comprises training the action selection neural network system to optimize an objective function that depends on a difference between a distribution of actions defined by the action selection policy outputs and a distribution of actions defined by the actions of the demonstrating agent.

8. The method of claim 1, further comprising training the image captioning neural network system by:
retrieving image observations from the multimodal demonstration data and retrieving image captions for the image observations, to obtain paired data items each comprising an image observation and a corresponding image caption;
training, using the paired data items, a decoder neural network subsystem configured to process an image caption to generate a decoder output, by:
processing the corresponding image caption for each of the paired data items, using the decoder neural network subsystem, to generate a respective decoder output, wherein the decoder output defines either a reconstruction of the image observation from the corresponding image caption or a value representing a likelihood that a sampled image observation, sampled from the multimodal demonstration data, corresponds to the image observation for the corresponding image caption; and
training the decoder neural network subsystem using a supervised loss dependent on the respective decoder output and a ground truth reference derived from the paired data items;
training an encoder neural network subsystem, configured to process an image observation to generate an image caption, by, for each of a plurality of image observations from the multimodal demonstration data:
processing the image observation using the encoder neural network subsystem to generate an imputed image caption; and
training the encoder neural network subsystem to maximize a likelihood of the image observation given the imputed image caption by maximizing an objective value dependent upon the decoder output for the imputed image caption; and
using the encoder neural network subsystem for the image captioning neural network system.

9. (canceled)

10. The method of claim 8, wherein the decoder output defines the reconstruction of the image observation from the corresponding image caption, wherein the ground truth reference derived from the paired data items comprises the image observation for the corresponding image caption, and wherein training the decoder neural network subsystem using the supervised loss comprises training using a supervised loss function that depends on a difference between the reconstruction of the image observation and the image observation for the corresponding image caption.

11. The method of claim 8, wherein the objective value dependent upon the decoder output for the imputed image caption comprises a first term dependent on a likelihood of a decoded image generated by processing the imputed image caption using the decoder neural network subsystem, and a second term representing a difference between a distribution of the imputed image captions and a distribution that defines a prior probability of the image captions.

12. The method of claim 8, wherein the decoder neural network subsystem comprises an image classifier neural network subsystem; wherein the decoder output defines a value representing a likelihood that a sampled image observation, sampled from the multimodal demonstration data, corresponds to the image observation for the corresponding image caption; and wherein the ground truth reference derived from the paired data items defines when the sampled image observation is one of either the image observation for the corresponding image caption or an image from which the corresponding image caption was generated using the encoder neural network subsystem.

13. The method of claim 8, further comprising:
obtaining a batch of image observations from the multimodal demonstration data;
obtaining a caption for a selected image observation in the batch either from the multimodal demonstration data or by processing the selected image observation using the encoder neural network subsystem;
determining a value of a contrastive loss function wherein the contrastive loss function comprises a combination of a likelihood that the selected image observation corresponds to the obtained caption and a likelihood that the other image observations in the batch do not correspond to the obtained caption;
wherein the image observation processed using the encoder neural network subsystem to generate the imputed image caption is the selected image observation; and
wherein the objective value dependent upon the decoder output for the imputed image caption is dependent upon the value of the contrastive loss function.

14. The method of claim 12, wherein the image classifier neural network subsystem comprises an image representation neural network configured to process the sampled image observation to generate a representation of the sampled image observation and a caption representation neural network configured to process the corresponding image caption to generate a representation of the corresponding image caption; the method further comprising determining the decoder output by determining a similarity between the representation of the sampled image observation and the representation of the corresponding image caption.

15. The method of claim 8, wherein the objective value dependent upon the decoder output for the imputed image caption comprises a second term dependent representing a difference between a distribution of the imputed image captions and a distribution that defines a prior probability of the image captions.

16. The method of claim 8, wherein training the encoder neural network subsystem by maximizing the objective value dependent upon the decoder output for the imputed image caption comprises:
determining a reward that depends on i) an accuracy of the reconstruction of the image observation from the corresponding image caption or the likelihood that the sampled image observation corresponds to the image observation for the corresponding image caption; and ii) a difference between a distribution of the imputed image captions and a distribution that defines a prior probability of the image captions; and
wherein processing the image observation using the encoder neural network subsystem to generate an imputed image caption defines a caption determination policy;
the method further comprising:
training the encoder neural network subsystem using a reinforcement learning technique to update the caption determination policy using the reward.

17. The method of claim 1, further comprising:
receiving a natural language description of a task;
providing an embedding of the natural language description of the task to the action selection neural network system; and
using the action selection neural network system to control the agent to select actions to perform the requested task in the environment.

18. (canceled)

19. (canceled)

20. (canceled)

21. The method of claim 1, comprising training the action selection neural network system using a simulation of a mechanical agent in a simulation of a real-world environment for using the action selection neural network system to control the mechanical agent in the real-world environment, wherein the observations relate to the real-world environment, and wherein the actions relate to actions to be performed by the mechanical agent acting in the real-world environment to perform the task.

22. The method of claim 1, wherein the agent is a mechanical agent, the environment is a real-world environment, the image observations are from one or more image sensors sensing the real-world environment, and the actions are for controlling the mechanical agent acting in the real-world environment to perform the task.

23. (canceled)

24. (canceled)

25. (canceled)

26. A system comprising one or more computers and one or more storage devices storing instructions that are operable, when executed by the one or more computers, to cause the one or more computers to perform operations for training an action selection neural network system to control an agent to select actions to perform a task in an environment,
wherein the action selection neural network system is configured to process an embedding of an observation, comprising an embedding of an image of the environment and an embedding of a natural language input, to generate an action selection policy output for selecting an action to be performed by the agent and a language policy output for generating a natural language output;
the operations comprising:
obtaining multimodal demonstration data comprising a plurality of task demonstration sequences, each task demonstration sequence comprising a sequence of demonstration observations and demonstration actions,
wherein the demonstration observations comprise image observations that characterize states of the environment while a demonstrating agent interacts with the environment to perform a task, and at least one natural language observation that describes the task that is performed, and wherein the demonstration actions characterize actions of the demonstrating agent in the environment as the task is performed;
processing embeddings of the demonstration observations using the action selection neural network system to generate the action selection policy output and the language policy output for the demonstration observations; and
training the action selection neural network system, using a natural language output defined by the language policy output, such that actions defined by the action selection policy outputs from the action selection neural network system are encouraged to match the actions of the demonstrating agent;
wherein training the action selection neural network system further comprises:
processing the image observations of the demonstration observations using an image captioning neural network system to generate natural language captions for the image observations; and
training the action selection neural network system using the natural language captions.

27. A computer storage medium encoded with instructions that, when executed by one or more computers, cause the one or more computers to perform operations for training an action selection neural network system to control an agent to select actions to perform a task in an environment,
wherein the action selection neural network system is configured to process an embedding of an observation, comprising an embedding of an image of the environment and an embedding of a natural language input, to generate an action selection policy output for selecting an action to be performed by the agent and a language policy output for generating a natural language output;
the operations comprising:
obtaining multimodal demonstration data comprising a plurality of task demonstration sequences, each task demonstration sequence comprising a sequence of demonstration observations and demonstration actions,
wherein the demonstration observations comprise image observations that characterize states of the environment while a demonstrating agent interacts with the environment to perform a task, and at least one natural language observation that describes the task that is performed, and wherein the demonstration actions characterize actions of the demonstrating agent in the environment as the task is performed;
processing embeddings of the demonstration observations using the action selection neural network system to generate the action selection policy output and the language policy output for the demonstration observations; and
training the action selection neural network system, using a natural language output defined by the language policy output, such that actions defined by the action selection policy outputs from the action selection neural network system are encouraged to match the actions of the demonstrating agent;
wherein training the action selection neural network system further comprises:
processing the image observations of the demonstration observations using an image captioning neural network system to generate natural language captions for the image observations; and
training the action selection neural network system using the natural language captions.
